(19) United States
(12) Patent Application Publication
(10) Pub. No.: US 2025/0316935 A1
(43) Pub. Date: Oct. 9, 2025

(54) CHARGING INLET

(71) Applicant: Yazaki Corporation, Tokyo (JP)

(72) Inventors: Masahiro SAWAYANAGI, Shizuoka (JP); Takahiro HORI, Shizuoka (JP); Hiroyuki SUZUKI, Shizuoka (JP)

(73) Assignee: Yazaki Corporation, Tokyo (JP)

(21) Appl. No.: 19/171,618

(22) Filed: Apr. 7, 2025

(30) Foreign Application Priority Data
Apr. 9, 2024 (JP) 2024-062534

(51) Int. Cl. H01R 13/717; B60L 53/16; H02J 7/00

(52) U.S. Cl. CPC H01R 13/7175; H02J 7/0049; B60L 53/16; H01R 2201/26

(57) ABSTRACT

A charging inlet includes: an inlet housing having a charging opening; an illuminator radiating light in which the charging opening is located within an irradiation area; and a reflective tape attached on an exterior surface of the inlet housing to fit a shape of at least a part of an outer periphery of the charging opening such that the reflective tape is located within the irradiation area with the light radiated from the illuminator. The illuminator includes a light source emitting the light of variable colors, and the light source may emit the light based on a radiation pattern corresponding to an operation status at the time of charging.

### CROSS REFERENCE TO RELATED APPLICATION

The present application is based on, and claims priority from the Japanese Patent Application No. 2024-062534, filed on Apr. 9, 2024, the entire contents of which are incorporated herein by reference.

### TECHNICAL FIELD

The present disclosure relates to a charging inlet.

### BACKGROUND

In the past, there has been provided a charging inlet which is installed in a vehicle such as an electric vehicle or a plug-in hybrid vehicle and supplies power to an on-vehicle battery from the outside of the vehicle. In addition, a device for displaying a charging state of the battery may be installed in the vicinity of a charging opening in the charging inlet. JP 2018-43744 A discloses a technology related to a vehicular illuminating device with a light emitter which is installed in the vicinity of a power supply port (charging opening) and causes a user to recognize a power-supply state (charging state) by changing the color and flashing appropriately.

### SUMMARY OF THE INVENTION

In the vehicular illuminating device disclosed in JP 2018-43744 A, as a part of an illumination unit, two kinds of light emitters are composed of a plurality of light sources, light guides, lenses, and reflectors. This complicates the overall structure of a charging inlet. Further, although these light emitters are installed in the vicinity of the charging opening, it is difficult to illuminate the entire charging opening. Therefore, the light emitters are insufficient as illuminations for assisting a power supply operation of the user at night.

An object of the present disclosure is to provide a charging inlet having an indicator function and an illumination function with a simple structure.

A charging inlet according to an aspect of embodiments includes: an inlet housing having a charging opening; an illuminator radiating light in which the charging opening is located within an irradiation area; and a reflective tape attached on an exterior surface of the inlet housing to fit a shape of at least a part of an outer periphery of the charging opening such that the reflective tape is located within the irradiation area with the light radiated from the illuminator.

According to the above configuration, it is possible to provide a charging inlet having an indicator function and an illumination function with a simple structure.

### BRIEF DESCRIPTION OF THE DRAWINGS

FIG. 1 is a perspective view of a charging inlet according to an embodiment.

FIG. 2 is a perspective view of the charging inlet when a reflective tape is attached.

FIG. 3 is a perspective view of a charging inlet according to another embodiment.

FIG. 4 is a table illustrating a radiation pattern of light corresponding to each operation status.

### DETAILED DESCRIPTION OF THE INVENTION

A charging inlet according to each embodiment will be described in detail below with reference to the drawings. Note that dimensional ratios in the drawings are exaggerated for convenience of the description and may be different from actual ratios.

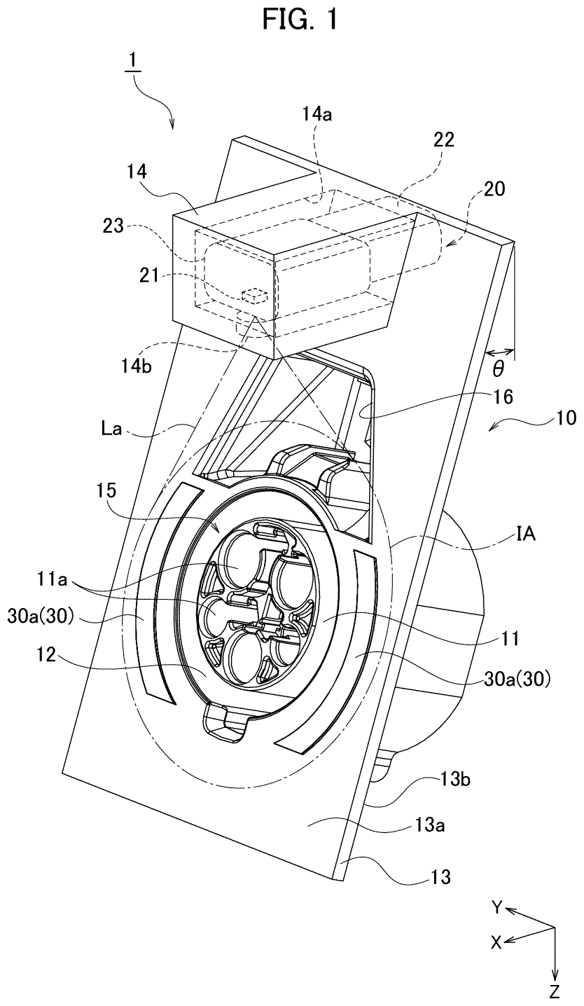

FIG. 1 is a perspective view of a charging inlet 1 according to an embodiment. Hereinafter, assuming that, as an example, the charging inlet 1 is installed in a vehicle and an illuminator 20 is installed in the charging inlet 1, directions are defined as follows. First, a Z direction corresponds to a vertical direction, and in the present embodiment, the Z direction also corresponds to a direction in which the illuminator 20 is attached relative to the charging inlet 1. Further, a horizontal plane orthogonal to the Z direction is defined as an XY plane, and an X direction and a Y direction are orthogonal to each other in the XY plane.

The charging inlet 1 is a connector which is installed in a vehicle such as an electric vehicle or a plug-in hybrid vehicle and supplies power to an on-vehicle battery by being appropriately connected to a charging connector (not illustrated) which is located outside of the vehicle. The outside charging connector is sometimes referred to as a “charging gun”. The charging inlet 1 includes a terminal holder (not illustrated) for holding a plurality of terminals, an inlet housing 10, the illuminator 20, and first reflective tapes 30a.

The inlet housing 10 is made of a synthetic resin, the front thereof exposed to the outside when being connected to the charging connector constitutes the exterior, and the terminal holder is mounted to the back thereof. The inlet housing 10 includes a cylindrical portion 11, a fitting frame 12, a flange 13, an illuminating device holder 14, and a lock hole 16, for example.

The cylindrical portion 11 has a plurality of terminal accommodating chambers 11a for individually accommodating and protecting connection portions of the plurality of terminals held by the terminal holder. The shape of each terminal accommodating chamber 11a is a cylindrical shape in which an external terminal to be connected to each terminal can be inserted therein. The inlet housing 10 may have a cylindrical portion other than the cylindrical portion 11 in order to conform to various charging system standards.

The fitting frame 12 is formed conforming to the outer peripheral shape of the cylindrical portion 11 and is fitted to a part of a housing disposed in the charging connector (hereinafter referred to as “external housing”). When the external housing is fitted to the fitting frame 12, power is supplied to the on-vehicle battery from an external power source or the like, and the on-vehicle battery is charged.

The flange 13 supports the cylindrical portion 11 and the fitting frame 12. The shape of the flange 13 illustrated in FIG. 1 is merely an example, and the specific shape of the flange 13 is determined according to a specification of the vehicle in which the charging inlet 1 is installed. A surface of the flange 13 exposed to the outside is an exterior surface 13a. In the present embodiment, the exterior surface 13a is an inclined surface having an inclination angle θ of about 20 degrees from a vertical plane. Openings of the cylindrical portion 11 and the fitting frame 12 opened to the outside from the exterior surface 13a are a charging opening 15.

The illuminating device holder 14 holds the illuminator 20 such that the illuminator 20 as an illuminating device illuminates the charging opening 15 of the charging inlet 1. The illuminating device holder 14 is disposed vertically above the charging opening 15 in the charging inlet 1 and has a box-shape protruding from the exterior surface 13a of the flange 13. The illuminating device holder 14 has therein an accommodator 14a which accommodates at least a distal end of the illuminator 20. The accommodator 14a is opened at a rear surface 13b on an opposite side of the exterior surface 13a of the flange 13, and the accommodator 14a can accommodate the illuminator 20 through the opening.

Further, the illuminating device holder 14 has an illumination opening 14b passing through from the accommodator 14a toward the charging opening 15. The illumination opening 14b is formed at a position where light emitted from a light source 21 disposed in the illuminator 20 can pass toward the charging opening 15. FIG. 1 illustrates both light La radiated from the illuminator 20 through the illumination opening 14b and an irradiation area IA with the light La using dash-dot-dash lines.

The lock hole 16 is a part of a safety mechanism disposed in the vicinity of the charging opening 15 in the flange 13. When the outside charging connector is connected to the charging opening 15, the lock hole 16 partially engages a lock claw (not illustrated) disposed in advance in the charging connector. This prevents the charging connector from falling off from the charging opening during a power supply operation. In the present embodiment, the lock hole 16 is disposed between the illuminating device holder 14 and the charging opening 15 in the flange 13.

The illuminator 20 radiates the light La in which the charging opening 15 is located within the irradiation area IA. Hereinafter, in the present embodiment, it is assumed that the illuminator 20 is an illuminating device which is attached to the illuminating device holder 14 of the inlet housing 10 in an attachable and detachable manner. FIG. 1 schematically illustrates the illuminator 20 arranged in the accommodator 14a of the illuminating device holder 14 using broken lines. The illuminator 20 includes at least a substrate (not illustrated) on which the light source 21 is mounted, a connector portion 22, and a case 23.

The light source 21 is installed on the substrate surface having the Z direction as a normal direction. Further, it is also assumed that a light emission direction from a light emission surface of the light source 21 is the Z direction. Here, the light emission direction is synonymous with a normal direction of the light emission surface, when the light emission surface is assumed to be approximately flat. The light source 21 may be a light emitting diode (LED), an organic electro-luminescence (EL) element, or the like.

Further, there is at least one light source 21. In the present embodiment, one light source 21 that emits light La of variable colors is adopted. The light source 21 may be an RGB color LED that emits multicolor light specified by RGB, for example. When the light source 21 is turned on to emit white light La, the light La can be used as illumination light for illuminating the charging opening 15. Further, when light La of various colors emitted from the light source 21 is lit or flashed appropriately, the light La can be used as display light suitable for indicator display, which is emitted based on a radiation pattern corresponding to an operation status at the time of charging.

In addition to the light source 21 such as the RGB color LED, the illuminator 20 may further include a light source 21 that emits monochromatic illumination light, such as an illumination LED that emits white light. In this case, the light sources can be used for different purposes. When a purpose is to radiate display light as an indicator function, light is emitted from the light source 21 which is the RGB color LED, while when a purpose is to radiate illumination light as an illumination function, light is emitted from the light source 21 which is the illumination LED.

The connector portion 22 is disposed in a housing as an insulating member for holding a substrate, and is connected to a vehicle-side connector (not illustrated) that constitutes a part of the charging inlet 1, for example.

The case 23 is made of a light transmissive material and houses and protects the substrate together with the housing in which the connector portion 22 is disposed. The case 23 is connected to the connector portion 22 through a packing (not illustrated). Therefore, the case 23 can also function as a waterproof mechanism to prevent water from entering the interior where the light source 21 is disposed.

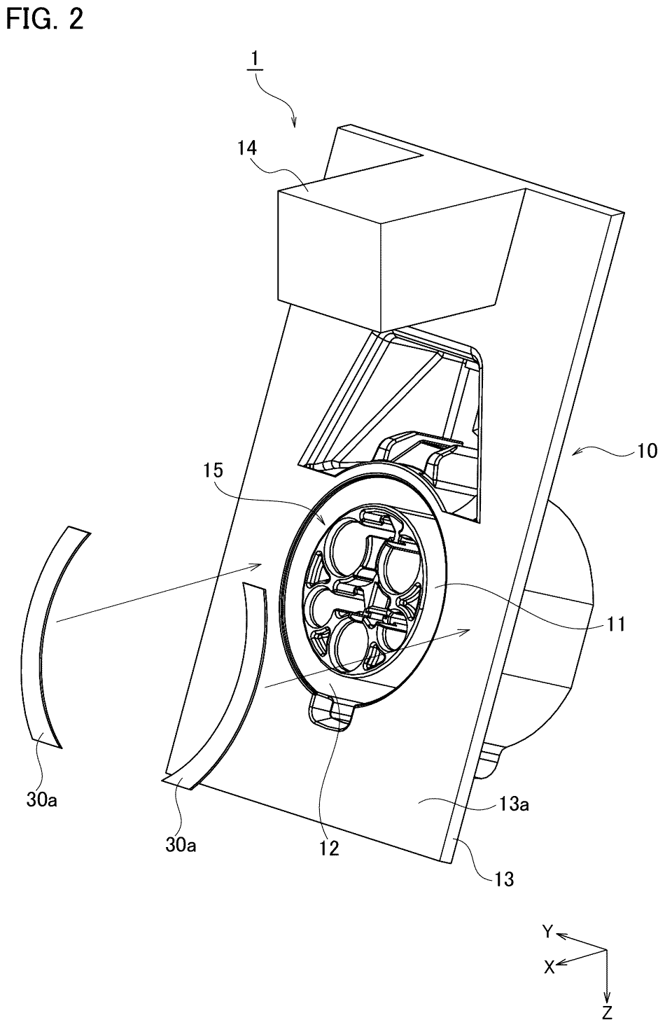

FIG. 2 is a perspective view of the charging inlet 1 when the first reflective tapes 30a are attached, which is drawn in accordance with FIG. 1 illustrating the charging inlet 1 after the attachment of the first reflective tapes 30a.

The first reflective tapes 30a are reflective tapes 30 in the present embodiment, which are attached on the exterior surface 13a of the flange 13 of the inlet housing 10. A surface of each reflective tape 30 is a reflecting surface for reflecting at least the light La entering from the light source 21. A rear surface of each reflective tape 30 is a surface on which an adhesive is applied in advance. Each reflective tape 30 is attached in advance to fit the shape of at least a part of the outer periphery of the charging opening 15 such that each reflective tape 30 is located within the irradiation area IA with the light La radiated from the illuminator 20.

The information that each reflective tape 30 is attached to fit the shape of at least a part of the outer periphery of the charging opening 15 means that, when an opening such as the lock hole 16 is disposed in the vicinity of the charging opening 15, each reflective tape 30 may not be attached to the opening, for example. In the present embodiment, in consideration of avoiding the opening such as the lock hole 16, the pair of first reflective tapes 30a that fit the shape of a part of the outer periphery of the charging opening 15 are present. As illustrated in FIG. 1, the pair of first reflective tapes 30a have shapes symmetrical to each other with the charging opening 15 therebetween, in the Y direction which is orthogonal to the Z direction of the illuminator 20 toward the charging opening 15.

The planar shape of the first reflective tapes 30a is a curved shape to fit the shape of at least a part of the outer periphery of the charging opening 15. In the present embodiment, the shape of the charging opening 15 is circular. Therefore, the planar shape of the first reflective tapes 30a is also a part of a circular planar shape.

One circular reflective tape 30 may be used, if there is no other opening or the like that inhibits the attachment of the reflective tapes 30 in the vicinity of the charging opening 15 on the exterior surface 13a of the flange 13.

The planar shape of the reflective tapes 30 is not limited to a curved planar shape like that of the first reflective tapes 30a.

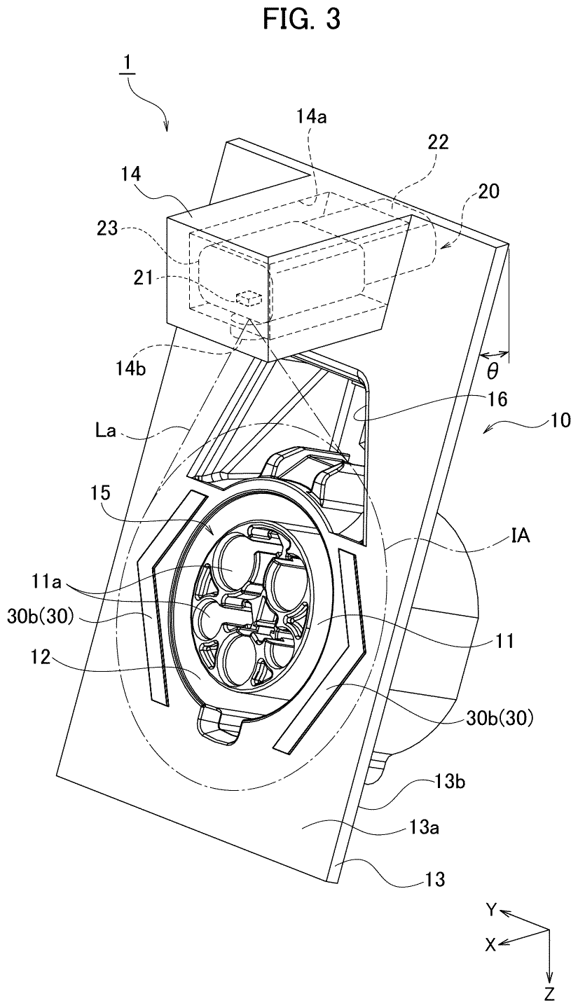

FIG. 3 is a perspective view of the charging inlet 1 according to another embodiment. In the charging inlet 1 illustrated in FIG. 3, instead of the first reflective tapes 30a illustrated in FIGS. 1 and 2, second reflective tapes 30b each having a planar shape which is a combination of linear portions are illustrated at the same position as the first reflective tapes 30a. In an example illustrated in FIG. 3, each of the pair of second reflective tapes 30b is constituted by a combination of two linear portions. Two linear portions of one second reflective tape 30b are combined such that the second reflective tape 30b is at least partially close to the charging opening 15. The second reflective tapes 30b having this kind of planar shape can exhibit a function equivalent to that of the first reflective tapes 30a by satisfying a condition that the second reflective tapes 30b are attached to fit the shape of at least a part of the outer periphery of the charging opening 15 such that the second reflective tapes 30b are located within the irradiation area IA with the light La radiated from the illuminator 20.

Next, a radiation pattern of the light La radiated from the illuminator 20 will be described.

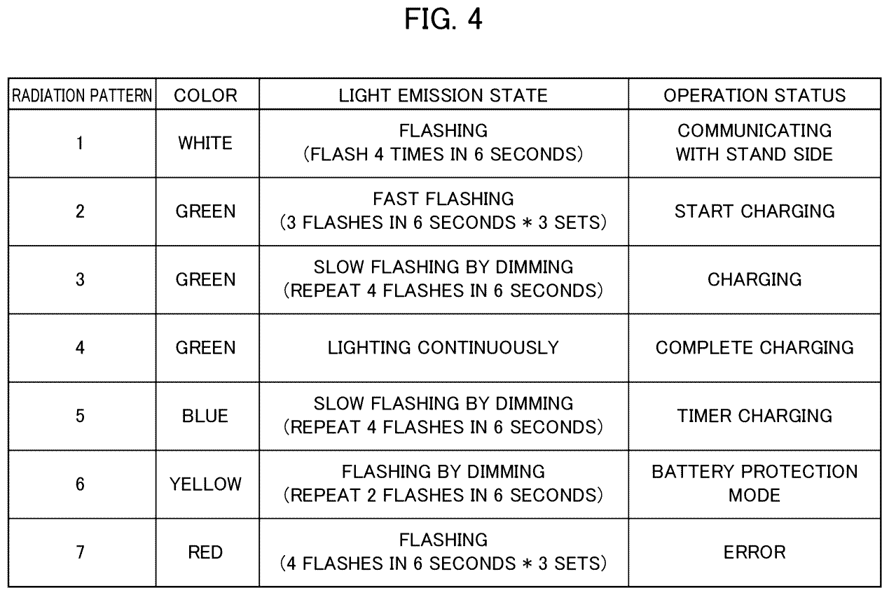

FIG. 4 is a table illustrating a radiation pattern of the light La corresponding to each operation status of the charging inlet 1.

In a first radiation pattern, the light source 21 is white and flashes 4 times in 6 seconds. When the light La is emitted in the first radiation pattern, as an operation status of the charging inlet 1, it is assumed that the charging inlet 1 is communicating with an external stand side where the charging connector is disposed.

In a second radiation pattern, the light source 21 is green and repeats 3 fast flashes in 6 seconds for 3 sets. Hereinafter, “fast flash” means that a flash is faster than the flash in the first radiation pattern. When the light La is emitted in the second radiation pattern, as an operation status of the charging inlet 1, it is assumed that charging is started.

In a third radiation pattern, the light source 21 is green and repeats 4 slow flashes in 6 seconds by dimming. Hereinafter, “slow flash” means that a flash is slower than the flash in the first radiation pattern. When the light La is emitted in the third radiation pattern, as an operation status of the charging inlet 1, it is assumed that charging is in progress.

In a fourth radiation pattern, the light source 21 is green and is continuously lit. When the light La is emitted in the fourth radiation pattern, as an operation status of the charging inlet 1, it is assumed that charging is completed.

In a fifth radiation pattern, the light source 21 is blue and repeats 4 slow flashes in 6 seconds by dimming. When the light La is emitted in the fifth radiation pattern, as an operation status of the charging inlet 1, it is assumed that a timer charging set to a desired charging time by a user is in progress.

In a sixth radiation pattern, the light source 21 is yellow and repeats 2 flashes in 6 seconds by dimming. When the light La is emitted in the sixth radiation pattern, as an operation status of the charging inlet 1, it is assumed that the charging inlet 1 is in a mode requiring battery protection.

In a seventh radiation pattern, the light source 21 is red and repeats 4 flashes in 6 seconds for 3 sets. When the light La is emitted in the seventh radiation pattern, as an operation status of the charging inlet 1, it is assumed that an error has occurred.

When the light source 21 radiates the light La in the radiation pattern described above, the light La is reflected by each reflective tape 30 located within the irradiation area IA and is directed toward the user as reflected light. The user can recognize an operation status of the charging inlet 1 at that time by recognizing the color, the flashing interval, and the like of the reflected light.

In addition to each radiation pattern illustrated in FIG. 4, an operation status type can be appropriately set. Further, the color and a lighting or flashing state in each radiation pattern can also be appropriately set.

Next, an effect of the charging inlet 1 will be described.

The charging inlet 1 includes the inlet housing 10 having the charging opening 15, and the illuminator 20 which radiates light in which the charging opening 15 is located within the irradiation area IA. The charging inlet 1 further includes the reflective tapes 30 attached on the exterior surface 13a of the inlet housing 10 to fit the shape of at least a part of the outer periphery of the charging opening 15 such that the reflective tapes 30 are located within the irradiation area IA with the light La radiated from the illuminator 20

First, in the charging inlet 1, the light La emitted from the light source 21 is used as illumination light for directly illuminating the charging opening 15, and therefore the light source can assist a power supply operation of the user at night as an illumination function.

Further, in the charging inlet 1, as an indicator function for allowing the user to recognize an operation status such as a charging state in the charging inlet 1, the light La also used as an illumination function is used as display light for indicator display. Specifically, the light source 21 appropriately changes the color, lighting or flashing state, or the like of the emitted light La according to an operation status of the charging inlet 1. The appropriately changed light La is reflected by each reflective tape 30 located within the irradiation area IA and is recognized by the user. The user can recognize an operation status of the charging inlet 1 at that time based on the state of the recognized light La.

Therefore, according to the charging inlet 1, the light source 21 used as an illumination function and indicator function is shared. Therefore, it is not necessary to dispose a light source for indicator display at a portion corresponding to each reflective tape 30. This can simplify the overall structure. Further, for the user, each reflective tape 30 disposed in the vicinity of the charging opening 15 is visibly shining. Therefore, the visibility is not greatly deteriorated compared with the case where a light source is separately disposed at a portion corresponding to each reflective tape 30. Moreover, since each reflective tape 30 can be easily processed, there is an advantage that the shape of each reflective tape 30 can be easily changed according to the design of the charging inlet 1.

As described above, according to the present embodiment, it is possible to provide the charging inlet 1 having the indicator function and illumination function with a simple structure.

Moreover, in the charging inlet 1, the illuminator 20 may have the light source 21 that emits light La of variable colors. The light source 21 may emit light La based on a radiation pattern corresponding to an operation status at the time of charging.

According to the charging inlet 1, as the indicator function, the user can easily recognize various radiation patterns from reflected light from each reflective tape 30 based on light La. This can easily cause the user to recognize various operation statuses such as charging states.

Further, the charging inlet 1 may have the pair of reflective tapes 30. In this case, the pair of reflective tapes 30 may fit the shape of a part of the outer periphery of the charging opening 15 and may have shapes symmetrical to each other with the charging opening 15 therebetween in a direction which is orthogonal to a direction of the illuminator 20 toward the charging opening 15.

In the above example, the direction of the illuminator 20 toward the charging opening 15 corresponds to the Z direction. In this case, a direction which is orthogonal to the direction of the illuminator 20 toward the charging opening 15 corresponds to the Y direction.

According to the charging inlet 1, the shape of each reflective tape 30 can be set in accordance with the configuration of the vicinity of the charging opening 15 in the inlet housing 10 to the extent that the visibility of the user is not affected.

In addition, in the charging inlet 1, the planar shape of each reflective tape 30 may be a curved shape to fit the shape of at least a part of the outer periphery of the charging opening 15.

In the above example, each reflective tape 30 corresponds to each first reflective tape 30a.

The light La radiated from the illuminator 20 is used as light to make each reflective tape 30 visibly shine for indicator display. Therefore, each reflective tape 30 needs to be located within the irradiation area IA. Meanwhile, according to the charging inlet 1, since the planar shape of each reflective tape 30 is a curved shape to fit the shape of at least a part of the outer periphery of the charging opening 15, each reflective tape 30 can be more efficiently located within the irradiation area IA. This can achieve higher visibility.

Further, the planar shape of each reflective tape 30 in the charging inlet 1 may be a combination of linear portions.

In the above example, each reflective tape 30 corresponds to each second reflective tape 30b.

According to the charging inlet 1, the shape of each reflective tape 30 can be set more easily than that of each reflective tape 30 having a curved planar shape, while suppressing deterioration in visibility.

In the above example, it is assumed that the illuminator 20 which radiates the light La toward the charging opening 15 is an illuminating device which is attached to the illuminating device holder 14 of the inlet housing 10 in an attachable and detachable manner. However, the configuration of the illuminator 20 is not limited to an illuminating device which is indirectly attached to the inlet housing 10, but the illuminator 20 may be directly incorporated into a part of the inlet housing 10.

Further, in the above example, it is assumed that the light source 21 that can emit light La of variable colors in the illuminator 20 emits the light La based on a radiation pattern corresponding to an operation status at the time of charging. However, it is not an essential condition that a light source that can emit light La of variable colors is adopted as the light source 21. Only an illumination LED that emits monochromatic illumination light such as white light may be adopted as the light source 21, for example. In this case, various radiation patterns corresponding to operation statuses at the time of charging can be set by appropriately changing the flashing interval or the flashing speed of illumination light.

While certain embodiments have been described, these embodiments have been presented by way of example only, and are not intended to limit the scope of the inventions. Indeed, the novel embodiments described herein may be embodied in a variety of other forms; furthermore, various omissions, substitutions, and changes in the form of the embodiments described herein may be made without departing from the spirit of the inventions. The accompanying claims and their equivalents are intended to cover such forms or modifications as would fall within the scope and spirit of the inventions.

1. A charging inlet comprising:
an inlet housing having a charging opening;
an illuminator radiating light in which the charging opening is located within an irradiation area; and
a reflective tape attached on an exterior surface of the inlet housing to fit a shape of at least a part of an outer periphery of the charging opening such that the reflective tape is located within the irradiation area with the light radiated from the illuminator.

2. The charging inlet according to claim 1, wherein
the illuminator includes a light source emitting the light of variable colors, and
the light source emits the light based on a radiation pattern corresponding to an operation status at the time of charging.

3. The charging inlet according to claim 1, wherein
the reflective tape is provided in plurality, and both of a pair of reflective tapes of the reflective tapes fit the shape of the part of the outer periphery of the charging opening and have shapes symmetrical to each other with the charging opening therebetween in a direction orthogonal to a direction of the illuminator toward the charging opening.

4. The charging inlet according to claim 1, wherein
a planar shape of the reflective tape is a curved shape to fit the shape of at least the part of the outer periphery of the charging opening.

5. The charging inlet according to claim 1, wherein
a planar shape of the reflective tape is a combination of linear portions.
